(19) United States
(12) Patent Application Publication
(10) Pub. No.: US 2014/0177304 A1
(43) Pub. Date: Jun. 26, 2014

(54) Constant Current Source

(71) Applicant: Laurence P. Sadwick, Salt Lake City, UT (US)

(72) Inventor: Laurence P. Sadwick, Salt Lake City, UT (US)

(21) Appl. No.: 14/140,453

(22) Filed: Dec. 24, 2013

Related U.S. Application Data
(60) Provisional application No. 61/745,676, filed on Dec. 24, 2012.

(51) Int. Cl. H02M 7/06

(52) U.S. Cl. CPC H02M 7/06
USPC 363/126

(57) ABSTRACT

A constant current source includes an alternating current input, a pair of capacitors connected in parallel with a load output, a pair of diodes connected in parallel with the pair of capacitors, wherein a first lead of the alternating current input is connected between the pair of diodes and a second lead of the alternating current input is connected between the pair of capacitors, and wherein capacitances of the pair of capacitors are selected to produce a substantially constant current to the load output at a voltage lower than that of the alternating current input.

### BACKGROUND

Electricity is typically generated and distributed in alternating current (AC) form, wherein the voltage varies sinusoidally between a positive and a negative value. However, many electrical devices require a direct current (DC) supply of electricity having a constant voltage level or constant current level, or at least a supply that remains positive even if the level is allowed to vary to some extent.

### SUMMARY

The driver disclosed herein provides power for any type of load, including lights such as LEDs of any type including, but not limited to, white and red/green/blue (RGB) LEDs and organic LEDs (OLEDs), battery chargers, and power supplies including providing power to start or drive the power supplies, drivers, ballasts, dimmers, etc. A circuit typically consisting of diodes and capacitors is used to supply a constant or essentially or nearly constant current for, among other things and uses, DC applications and, in particular AC to DC applications although in some instances, AC to AC applications.

This summary provides only a general outline of some particular embodiments. Many other objects, features, advantages and other embodiments will become more fully apparent from the following detailed description.

### BRIEF DESCRIPTION OF THE DRAWINGS

A further understanding of the various embodiments of the present invention may be realized by reference to the figures which are described in remaining portions of the specification. In the figures, like reference numerals may be used throughout several drawings to refer to similar components.

FIG. 1 depicts a schematic diagram of an AC to DC constant current power converter in accordance with some embodiments of the invention;

FIG. 2 depicts a representative constant current waveform of an AC to DC constant current source power converter in accordance with some embodiments of the invention;

FIG. 3 depicts a representative voltage waveform of an AC to DC power converter in accordance with some embodiments of the invention;

FIG. 4 depicts a schematic of one example circuit implementation with the optional filter/filtering consisting in this example of capacitor C3 in accordance with some embodiments of the invention;

FIG. 5 depicts a power source for a constant current source power converter in accordance with some embodiments of the invention;

FIG. 6 depicts another power source with output ripple filtering for a constant current source power converter in accordance with some embodiments of the invention;

FIG. 7 depicts another power source with output ripple filtering and showing an example integrated circuit load for a constant current source power converter in accordance with some embodiments of the invention;

FIG. 8 depicts another power source for a constant current source power converter in accordance with some embodiments of the invention;

FIG. 9 depicts another power source for a constant current source power converter in accordance with some embodiments of the invention;

FIG. 10 depicts another power source with full rectification for a constant current source power converter in accordance with some embodiments of the invention;

FIG. 11 depicts an AC to DC constant current power converter with a power source in accordance with some embodiments of the invention;

FIG. 12 depicts an AC to DC constant current power converter with a power source and ripple filter and an example integrated circuit load in accordance with some embodiments of the invention;

FIG. 13 depicts an AC to DC constant current power converter with a transistor-controlled power source and ripple filter in accordance with some embodiments of the invention; and

FIG. 14 depicts an AC to DC constant current power converter with a transistor-controlled power source and ripple filter and an example integrated circuit load in accordance with some embodiments of the invention.

### DESCRIPTION

The constant current source disclosed herein provides constant current over a wide range of loads providing power from sources such as AC line voltage sources for use in powering any electronic circuits or devices. For example, to provide power to internal circuits in a dimmable LED driver, non-dimmable LED driver, FL, CFL, CCFL ballast, forward/reverse dimmer, and/or battery charger such as the various dimmable LED drivers and their variations disclosed in U.S. Patent Application 61/646,289 filed May 12, 2012 for a “Current Limiting LED Driver”, and in U.S. Pat. No. 8,148,907 issued Apr. 3, 2012 for a “Dimmable Power Supply”, which are incorporated herein by reference for all purposes. In some embodiments, power may be provided to charge one or more batteries or other energy storage devices or for use in providing start-up power to various types of power supplies and drivers including general purpose, electronic devices such as power supplies and power adaptors for computers, laptops, cellular phones, tablets, iPods, iPads, iPhones, etc, and general lighting including LEDs, OLEDs, fluorescent tubes (FLs) including compact FLs (CFLs), etc. By a judicious choice of components, current and power can be tailored to meet the specifics of the applications.

The present invention can be used in, among other things, for example, forward and reverse dimmers, LED and OLED power supplies and drivers for AC and ballast applications, ballasts, and various applications such as, but not limited to, those disclosed in U.S. patent application Ser. No. 14/071,345 filed Nov. 4, 2013 for a “Dimmer with Motion and Light Sensing”, and in U.S. patent application Ser. No. 13/760,911 filed Feb. 6, 2013 for a “Fluorescent Lamp Dimmer”, and in U.S. patent application Ser. No. 13/073,959, filed Mar. 28, 2011 for a “Power Supply for LED Fluorescent Lamp Replacement”, which are incorporated herein by reference for all purposes.

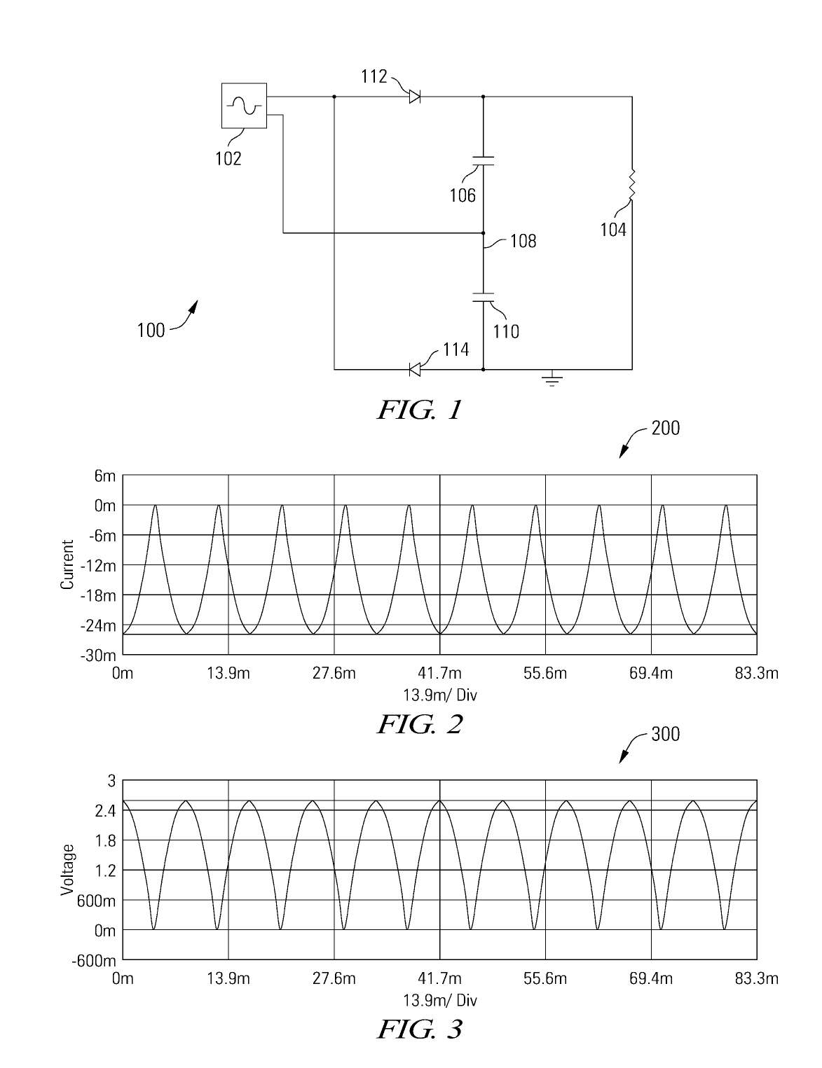

The present invention can be used independently as a stand alone power supply or as part of a power supply system in which power may be obtained from sources such as but not limited to an AC or DC line, a tag-along inductor that inductively couples to another inductor in an electrical circuit, a battery, solar cells, photovoltaics, vibrational, heat, mechanical, sources, etc. The present invention can also use other circuits and components including, for example, voltage and/or current regulators, voltage references, etc. The present invention can also be used to provide power to drive analog and/or digital and/or wired or wireless electronics including, but not limited to microcontrollers, microprocessors, digital signal processors (DSPs), WiFi, ZigBee, IEEE 801, ISM, and other RF, millimeter-wave, etc. radio chips and integrated circuits, infrared, powerline control, serial and parallel communications including but not limited to SPI, I2C, SPC, USB, RS232, DMX, DALI, RS485, CAM, etc., FPGAs, CLDs, digital logic, op amps, comparators, timers, flip flops, counters, analog to digital converters, digital to analog converters, etc. The present invention can provide current at voltages ranging from less than a few volts to greater than dozens of volts or higher in a highly efficient manner and way, including, for example, 3 volts, 5 volts, 10 volts, 15 volts, 24 volts, 48 volts, 100 volts, etc. Tables 1 and 2 illustrate two example cases of the present invention utilizing the circuit depicted in FIG. 1 with two different sets of capacitance values for C1 and C2 with the data shown in Table 2 having values for the capacitors C1 and C2 four times that of the data shown in Table 1 below. As can be seen from the tables below, the current increases approximately four-fold with a four-fold increase in capacitors C1 and C2. As can also be seen from the tables, the current remains essentially constant for a given value of C1 and C2 regardless and independent of the resistance value over, for the examples shown in Tables 1 and 2, a range of resistance values from 100 to 2 kohms (a ration of 1 to 20) and a range of resistance values from 100 to 1 kohms (a ration of 1 to 10), respectively.

TABLE 1

| Resistance (Ω) | Current (mA) | Voltage (V) |
|---|---|---|
| 100 | 6.5 | 0.65 |
| 200 | 6.5 | 1.3 |
| 500 | 6.5 | 3.2 |
| 1k | 6.5 | 6.45 |
| 2k | 6.45 | 12.9 |

TABLE 2

| Resistance (Ω) | Current (mA) | Voltage (V) |
|---|---|---|
| 100 | 25.8 | 2.56 |
| 200 | 25.8 | 5.15 |
| 500 | 25.6 | 12.8 |
| 1k | 25.5 | 25.4 |

When used to power a light such as an LED of any type, the driver draws an alternating current (AC) current from an AC source to provide a direct current (DC) supply of electricity with a constant voltage level or constant current level, or at least a supply that remains positive even if the level is allowed to vary to some extent. For example, light emitting diodes (LEDs) and similar devices such as organic light emitting diodes (OLEDs) are being increasingly considered for use as light sources in residential, commercial and municipal applications. However, in general, unlike incandescent light sources, LEDs and OLEDs cannot be powered directly from an AC power supply unless, for example, the LEDs are configured in some back to back formation. Electrical current flows through an individual LED easily in only one direction, and if a negative voltage which exceeds the reverse breakdown voltage of the LED is applied, the LED can be damaged or destroyed. Furthermore, the standard, nominal residential voltage level is typically something like 120 V or 240 V, both of which are often higher than may be desired for a high efficiency LED light. Some conversion of the available power may therefore be necessary or highly desired with loads such as an LED light. When used to power electronics including ICs of virtually any type, the same AC to DC approaches apply with the present invention being able to provide current and power to the electronics including ICs of virtually any type and kind including in a floating power supply format.

An example of a relatively simple circuit with such an AC current waveform is shown in FIG. 1. FIG. 2 shows the associated AC current waveform for a typical simple circuit as depicted in FIG. 1.

FIG. 1 depicts a schematic diagram of a AC to DC constant current power converter 100 consisting of a circuit that appears to have a topology similar to a voltage doubler in accordance with some embodiments of the invention. The term “voltage doubler” is used herein to refer to a circuit that draws current from an input to an output, such as the voltage doubler consisting of capacitors 106, 110 and diodes 112, 114. The term “voltage doubler” does not imply herein that an output voltage is twice the input voltage including over the complete AC cycle and, in fact, by properly choosing capacitors 106 and 110, the present invention does not double the input voltage but, in fact, both lowers the output voltage compared to the input voltage and produces a constant current output over a wide range of loads.

An AC input 102 has a first lead connected to a central node 108 between capacitors 106, 110, and another lead connected to the opposite sides of capacitors 106, 110 through diodes 112, 114. Diodes 112 and 114 and capacitors 106 and 110 form a voltage reduced constant current output. A load (e.g., 104) of any type can be connected in parallel with capacitors 106, 110. Although passive and/or active methods can be used in the present invention, by a judicious and careful choice of component values, the circuits depicted in FIGS. 1 through 14 can be designed and implemented such that the circuit automatically passively provides constant current and power to the load.

The capacitance of capacitors (e.g., 106, 110) is selected in some embodiments to be small enough that the voltage doubler is active mainly or entirely at a low output voltage, constant current mode of operation.

Current and voltage waveforms 200, 300 across load 104 are shown in FIGS. 2 and 3 for some example embodiments of the constant current source with example component values.

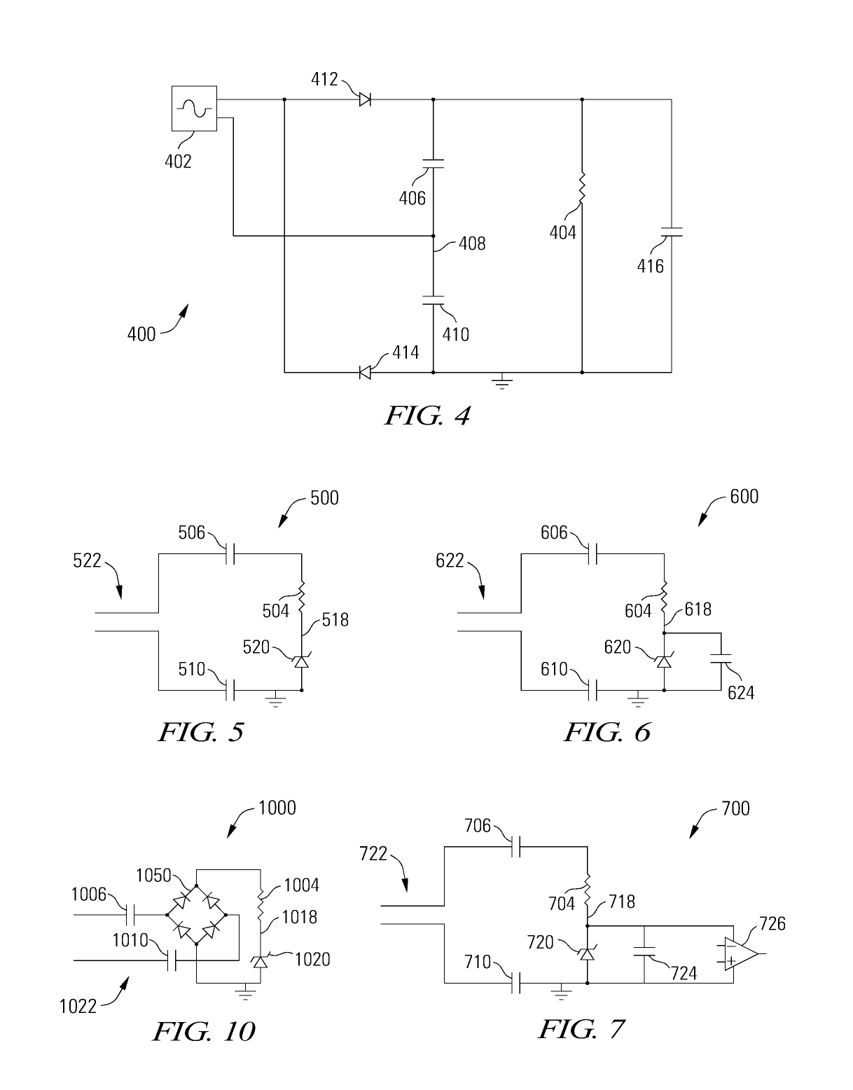

As shown in FIG. 4, some embodiments of a constant current source 400 include ripple filtering or other filtering, for example by including capacitor 416 in parallel with load 404 and capacitors 406, 410. As with the embodiment of FIG. 1, an AC input 402 has one lead connected to a central node 408 between capacitors 406, 410 and another lead connected through diodes 412, 414 across capacitors 406, 410.

Turning to FIG. 5, an example embodiment of a power source 500 for the present invention consisting of capacitors 506, 510 connected to an AC input 522 with a resistor 504 and Zener diode 520 connected between capacitors 506, 510. The resistor 504 and Zener diode 520 are of appropriate values and voltage ratings for a particular application such that the junction/node 518 between resistor 504 and Zener diode 520 provides an appropriate/desired voltage (and current) to a load (not shown in FIG. 5). Power from node 518 may be used for any purpose, for example, to power integrated circuits and/or other components in a dimming driver for lighting or other loads. An optional capacitor or capacitors (not shown in FIG. 5) may be added to reduce the ripple, for example, at the output.

In some embodiments as in FIG. 10, the power source 1000 includes a rectifier 1050. Capacitors 1006, 1010 are connected to AC input 1022. Resistor 1004 and Zener diode 1020 are of appropriate values and voltage ratings for a particular application such that the junction/node 1018 between resistor 1004 and Zener diode 1020 provides an appropriate/desired voltage (and current) to a load (not shown in FIG. 10). Diode bridge 1050 is connected between capacitors 1006, 1010 and resistor 1004 and Zener diode 1020 to provide rectified current across resistor 1004.

FIG. 6 depicts an example embodiment of a power source 600 for the present invention consisting of capacitors 606, 610 connected to AC input 622 and with a resistor 604 and Zener diode 620 of appropriate voltage for a particular application such that the junction/node 618 between resistor 604 and Zener diode 620 provides an appropriate/desired voltage (and current) to a load (not shown in FIG. 6). A capacitor 624 (or capacitors) has been included to reduce the ripple at the output at node 618.

FIG. 7 depicts an example embodiment of a power source 700 for the present invention consisting of capacitors 706, 710 connected to an AC input 722 with a resistor 704 and Zener diode 720 connected between capacitors 706, 710. The resistor 704 and Zener diode 720 are of appropriate values and voltage ratings for a particular application such that the junction/node 718 between resistor 704 and Zener diode 720 provides an appropriate/desired voltage (and current) to a load such as an integrated circuit 726. Power from node 718 may be used for any purpose, for example, to power integrated circuits (e.g., 726) and/or other components in a dimming driver for lighting or other loads. An optional capacitor 724 or capacitors may be added to reduce the ripple, for example, at the output. Note although only a single IC 726 is shown in FIG. 7, any number of ICs, transistors, other active and passive, etc. components may be used with the present invention including, but not limited to the embodiment depicted in FIG. 7.

FIG. 8 depicts an example embodiment of a power source 800 for the present invention consisting of capacitors 806, 810 connected to AC input 822 with resistor 804 and Zener diode 820, transistor 834, capacitor 824 and resistor 832 forming a voltage regulator. Such a voltage regulator can be used to provide voltage and current to a load such as integrated circuit (IC) 826 which may be the output of certain embodiments of the present invention. Note although only a single IC 826 is shown in FIG. 8, any number of ICs, transistors, other active and passive, etc. components may be used with the present invention including, but not limited to the embodiment depicted in FIG. 8. Additional capacitors may be optionally included including, for example, adding addition capacitors to capacitor 824. Embodiments of the present invention are not limited to the voltage regulator depicted in FIG. 8 or any other figure contained within or any type of transistor or transistors. Note that although a MOSFET is depicted in FIG. 8, the present invention and associated embodiments may include and use any type of transistor as discussed further below including, but not limited to, MOSFETs, BJTs, Darlington transistors, JFETs, etc. Furthermore, in general, any type of voltage (or current) regulator including series, shunt, linear, switching, hybrid, combination of these, etc. may be used with the present invention. Note that the effective local ground 840 as depicted in FIG. 8 is for illustrative purposes only and is in no way or form limiting for the present invention. In fact the present invention allows and is designed for in many embodiments of the present invention to be floating and allow the associated power supplies to be able to float. The present invention allows for grounded or referenced connections to be selected and made as the application and need requires. Embodiments of the present invention are not limited to the voltage regulator depicted in FIG. 8 or any other figure contained within or any type of transistor or transistors. In general, any type of voltage (or current) regulator including series, shunt, linear, switching, hybrid, combination of these, etc. may be used with the present invention. Note that the circuit as depicted in FIG. 8 is for illustrative purposes only and is in no way or form limiting for the present invention. The present invention allows and is designed for in many embodiments of the present invention to be floating and allow the associated power supplies to be able to float. The present invention allows for grounded or referenced connections to be selected and made as the application and need requires.

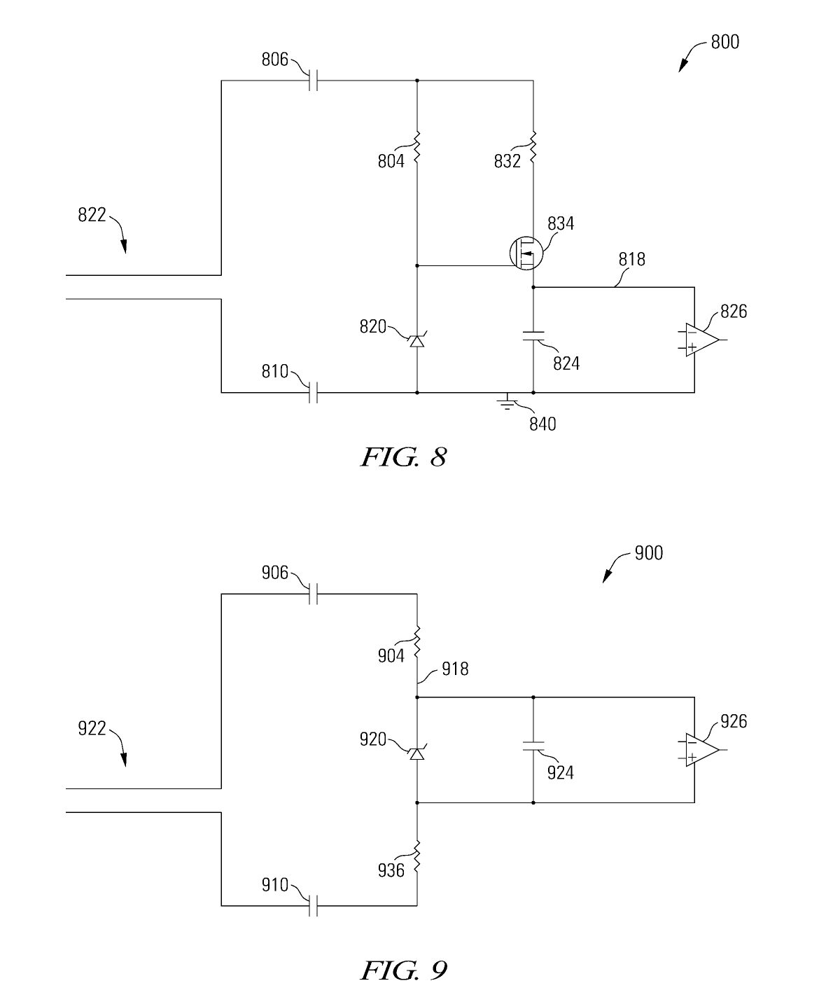

FIG. 9 depicts an example embodiment of a power source 900 for the present invention consisting of capacitors 906, 910 with resistors 904, 936 and Zener diode 920 of appropriate voltage for a particular application such that the junction/node 918 between resistor 904 and Zener diode 920 provides an appropriate/desired voltage (and current) to a load such as integrated circuit (IC) 926 which may be the output of certain embodiments of the present invention. Note although only a single IC 926 is shown in FIG. 9, any number of ICs, transistors, other active and passive, etc. components may be used with the present invention including, but not limited to the embodiment depicted in FIG. 9. Filter capacitor 924 and additional capacitors may be optionally included including, for example, adding addition capacitors to 924.

Note although only a single IC is shown in FIG. 9, any number of ICs, transistors, other active and passive, etc. components may be used with the present invention including, but not limited to the embodiment depicted in FIG. 9. Resistors 804, 832, Zener diode 820, transistor 834 and capacitor 824 form a floating voltage regulator. Embodiments of the present invention are not limited to the voltage regulator depicted in FIGS. 8 and 9 or any other figure contained within or any type of transistor or transistors. in general, any type of voltage (or current) regulator including series, shunt, linear, switching, hybrid, combination of these, etc. may be used with the present invention. Note that although a MOSFET is depicted in FIG. 8, the present invention and associated embodiments may include and use any type of transistor as discussed further below including, but not limited to, MOSFETs, BJTs, Darlington transistors, JFETs, etc. Note that the circuit as depicted in FIG. 9 is for illustrative purposes only and is in no way or form limiting for the present invention. The present invention allows and is designed for in many embodiments of the present invention to be floating and allow the associated power supplies to be able to float. The present invention allows for grounded or referenced connections to be selected and made as the application and need requires.

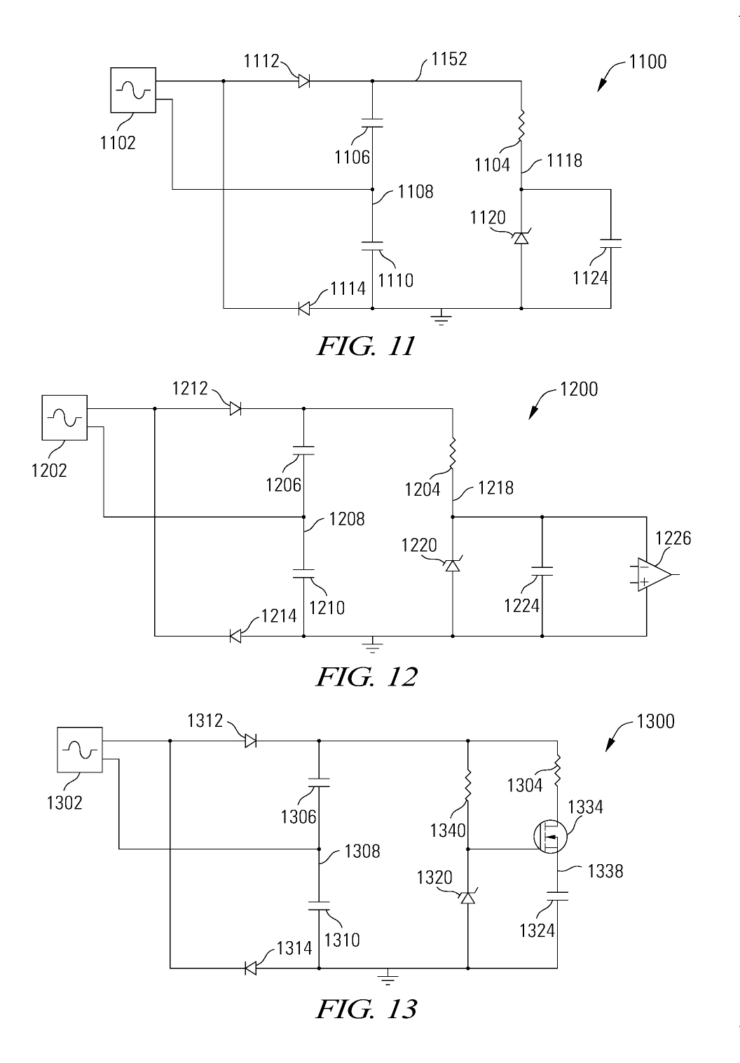

Turning to FIG. 11, a constant current source 1100 has one lead of an AC input 1102 connected to a central node 1108 between capacitors 1106, 1114, and with another lead of the AC input 1102 connected through diodes 1112, 1114 across capacitors 1106, 1110. The values of capacitors 1106, 1110 are selected to yield a constant current at node 1152 with a voltage lower than that of the AC input 1102, yielding a relatively low voltage constant current output. A voltage regulator comprising resistor 1104, Zener diode 1120 and capacitor 1124 provide a regulated voltage at output node 1118 from the constant current at node 1152, which can be used to power any suitable load such as, but not limited to, active circuit elements of a dimming driver, such as the integrated circuit 1226 of FIG. 12.

In the constant current source 1200 of FIG. 12, one lead of an AC input 1202 is connected to a central node 1208 between capacitors 1206, 1214, and another lead of the AC input 1202 is connected through diodes 1212, 1214 across capacitors 1206, 1210. The values of capacitors 1206, 1210 are selected to yield a constant current at node 1252 with a voltage lower than that of the AC input 1202, yielding a relatively low voltage constant current output. A voltage regulator comprising resistor 1204, Zener diode 1220 and capacitor 1224 provide a regulated voltage at output node 1218 from the constant current at node 1252, which can be used to power any suitable load such as, but not limited to, active circuit elements of a dimming driver, such as the integrated circuit 1226.

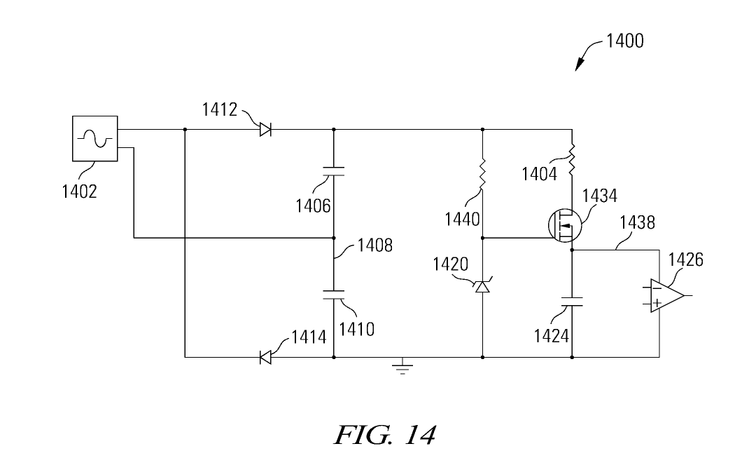

Turning to FIG. 13, a constant current source 1300 has one lead of an AC input 1302 connected to a central node 1308 between capacitors 1306, 1314, and with another lead of the AC input 1302 connected through diodes 1312, 1314 across capacitors 1306, 1310. The values of capacitors 1306, 1310 are selected to yield a constant current at node 1352 with a voltage lower than that of the AC input 1302, yielding a relatively low voltage constant current output. A voltage regulator comprising resistor 1304, Zener diode 1320, transistor 1334 resistor 1304, and capacitor 1324 provide a regulated voltage at output node 1318 from the constant current at node 1352, which can be used to power any suitable load such as, but not limited to, active circuit elements of a dimming driver, such as the integrated circuit 1426 of FIG. 14.

Turning to FIG. 14, a constant current source 1400 has one lead of an AC input 1402 connected to a central node 1408 between capacitors 1406, 1414, and with another lead of the AC input 1402 connected through diodes 1412, 1414 across capacitors 1406, 1410. The values of capacitors 1406, 1410 are selected to yield a constant current at node 1452 with a voltage lower than that of the AC input 1402, yielding a relatively low voltage constant current output. A voltage regulator comprising resistor 1404, Zener diode 1420, transistor 1434 resistor 1404, and capacitor 1424 provide a regulated voltage at output node 1418 from the constant current at node 1452, which can be used to power any suitable load such as, but not limited to, active circuit elements of a dimming driver, such as the integrated circuit 1426.

Embodiments of the present invention are not limited to the voltage regulator depicted in FIG. 8 or any other figure disclosed herein, or to any type of transistor or transistors. Note that although a MOSFET is depicted in FIG. 8 and other figures, the present invention and associated embodiments may include and use any type of transistor as discussed further below including, but not limited to, MOSFETs, BJTs, Darlington transistors, JFETs, etc. Furthermore, in general, any type of voltage (or current) regulator including series, shunt, linear, switching, hybrid, combination of these, etc. may be used with the present invention. Note that the effective local ground as depicted in FIG. 8 and other figures is for illustrative purposes only and is in no way or form limiting for the present invention. In fact the present invention allows and is designed for in many embodiments of the present invention to be floating and allow the associated power supplies to be able to float. The present invention allows for grounded or referenced connections to be selected and made as the application and need requires.

Note that more than one of the power sources and circuits illustrated in FIGS. 1-14 may be present and used in certain embodiments of the present invention; for example, two of more of the present invention, for example, in any combination may be used to provide, for example, 3 volts for logic and microprocessors, etc. and 15 volts to drive the MOSFET gates of, for example, LED and OLED drivers, forward and reversed dimmers, LED drivers for use in/with fluorescent lamp ballasts, etc. In some instances three (i.e., 3 volts, 5 volts, and 15 volts) or more such power supplies may be used in certain embodiments where the local grounds may or may not be connected together to a common ground. For example, two or more of the current source power supplies of the present invention may be connected together to form a common ground while other current sources of the present invention may or may not be connected to this same common local ground or to different common local grounds.

The present invention is applicable to many types of power supplies, drivers, ballasts, dimmers, battery chargers, etc. including ones using, for example, boost-buck, buck-boost, boost, buck, isolated, non-isolated, flyback, SEPIC, Cuk, push-pull, forward-converters including voltage and current modes, etc. and related circuits, approaches, and topologies, etc. The term “power source” is used herein to refer to the origin of a voltage or current, in contrast to a circuit such as a voltage regulator that may scale, limit or otherwise process the voltage and/or current levels obtained from the power source. Examples of power sources include but are not limited to AC and/or DC lines, tag-along inductors, transformers, batteries, energy harvesting sources such as solar, photovoltaic, mechanical, vibrations, wireless, etc.

The present invention, for example, may be used in conjunction with a dimmable LED driver, non-dimmable LED driver, FL, CFL, CCFL ballast, and/or battery charger that powers and controls a load such as one or more LED lights, from a power source such as an AC input. A rectifier may be used to convert the AC input and provide a DC signal to a DC rail. As will be understood by those of ordinary skill in the art, other components may be included such as capacitor in parallel with load 110, and other devices to facilitate the desired functionality in the dimmable LED driver. In other embodiments, the load may consist of one or more capacitors in parallel with the LED(s), etc. In other embodiments and applications, the load may consist of things other than LEDs, OLEDs, etc., such as, but not limited to resistive, capacitive, inductive, reactive, batteries, start-up circuits, drive power supplies, auxiliary power sources, bias power supplies, power sources for ICs, including virtually any type of IC such as ICs for LED and/or OLED power supplies and drivers, ICs for ballasts, ICs for dimmers including, but not limited to, triac, forward and reverse dimmers, etc., ICs for linear or switching power supplies, ICs for PWM circuits, power supplies, etc., power supplies and chargers or part of power supplies and/or power chargers for computers, cellular phones, tablets, etc. and/or combinations of these, etc.

As mentioned above, batteries, solar cells, photovoltaics, vibrational, mechanical, heat, thermal, wired, wireless, RF, etc. sources of energy may also be used with the present invention. In some embodiments of the present invention only one capacitor (i.e., C1 or C2) may be needed and used.

The multiple power paths are not limited to use in any particular application. In other example embodiments of dimmable LED drivers, non-dimmable LED drivers, FL, CFL, CCFL ballasts, battery chargers, etc. a controller measures the load current through a sense resistor, and controls a variable pulse generator based in part upon the load current. In some versions a level shifter or isolator may be included and may be used to feed the signal from the sense resistor to the controller or a sense transformer or other such device may be used as well as transistors to convey information about the current through the load. Other embodiments of the present invention may use other methods to sense current including, but not limited to, current transformers, voltages across or through components, turns of wire, magnetic sensors, etc. As mentioned above, although not required for the present invention, some applications and/or embodiments may use level shifters, optocouplers, opto-isolators, transistors, etc. as part of the feedback. The present invention may or may not use such level shifting and is, in no way or form, limited to the use or non-use of level shifting, etc. The variable pulse generator may further be controlled by the current level through the switch as measured by another sense resistor or other means. A snubber circuit may be included to suppress transient voltages and improve noise performance, etc. One or more clamp circuits may also be used. As mentioned above, the energy and associated power with the snubber(s) and/or clamp(s)may be used as part of the multiple power sources. A It is important to note that the present invention is not limited to use with, for example, a dimmable LED driver, non-dimmable LED driver, FL, CFL, CCFL ballast, battery charger, forward or reverse dimmer etc., nor to the specific details of the power sources, which are merely examples. Although two diodes and capacitors are illustrated in the example drawings contained herein, in general, N components including diodes and capacitors may be used

Although the selection of power sources and power paths in the above example embodiments involved diodes, the present invention is in no way limited to the use of diodes only; the selection can be made, for example, by diodes, switches, transistors, other types of semiconductor and active and passive components, digital and/or analog methods, techniques, approaches, etc., by monitoring and selecting certain voltage values, etc. These examples are meant to be illustrative and in no way or form limiting for the present invention.

The present invention can also include passive and active components and circuits that assist, support, facilitate, etc. the operation and function of the present invention. Such components can include passive components such as resistors, capacitors, inductors, filters, transformers, diodes, other magnetics, combinations of these, etc. and active components such as switches, transistors, integrated circuits, including ASICs, microcontrollers, microprocessors, digital signal processors (DSPs), field programmable gate arrays (FPGAs), complex logic devices (CLDs), programmable logic, digital and or analog circuits, and combinations of these, etc. and as also discussed below.

The present invention can be used in power supplies, drivers, ballasts, etc. with or without dimming including triac, forward and reverse dimmers, 0 to 10 V dimming, powerline dimming, monitoring and/or control, wireless and other wired dimming, DALI dimming, PWM dimming, DMX, etc., as well as any other dimming and control protocol, interface, standard, circuit, arrangement, hardware, etc.

In general there can be additional tag-along inductors to provide additional power sources for the present invention and other additional power sources such that use photovoltaics, solar cells, thermal, mechanical, vibrational, wired, wireless, RF, heat, etc.

Components in the dimmable LED driver, non-dimmable LED driver, FL, CFL, CCFL ballast, battery charger, etc. are powered by either or both the power source that draws power from the positive rail or the power source that draws power from a tag-along inductor. Power sources are merely discussed for illustrative purposes and are in no way limiting in any way or form, and any implementation with multiple sources of power is included in the present invention and associated embodiments.

Time constants may be included in various locations in the feedback loop or in other locations as desired to implement different control schemes or to adjust the response of the dimmable LED power supply, non-dimmable LED driver, FL, CFL, CCFL ballast, battery charger, etc. and/or the multiple voltage/power paths. Time constants may be connected to the local ground if and as needed, for example if the time constant consists of an RC network with the signal passing through a series resistor and with a shunt capacitor connected to the local ground. If the op amp or comparator does not share a common local ground with the control and/or pulse generation circuits than additional power sources as discussed above may be used. In other embodiments the feedback, control and pulse generation may all be combined into one functional unit or integrated circuit.

The example embodiments disclosed herein illustrate certain features of the present invention and not limiting in any way, form or function of present invention. Note that linear or switching voltage or current regulators or any combination can be used in the present invention and other elements/components can be used in place of the diodes, etc.

The present invention is, likewise, not limited in materials choices including semiconductor materials such as, but not limited to, silicon (Si), silicon carbide (SiC), silicon on insulator (SOI), other silicon combination and alloys such as silicon germanium (SiGe), etc., diamond, graphene, gallium nitride (GaN) and GaN-based materials, gallium arsenide (GaAs) and GaAs-based materials, etc. The present invention can include any type of switching elements including, but not limited to, field effect transistors (FETs) such as metal oxide semiconductor field effect transistors (MOSFETs) including either p-channel or n-channel MOSFETs, junction field effect transistors (JFETs), metal emitter semiconductor field effect transistors, etc. again, either p-channel or n-channel or both, bipolar junction transistors (BJTs) including Darlington transistors, heterojunction bipolar transistors (HBTs), high electron mobility transistors (HEMTs), unijunction transistors, modulation doped field effect transistors (MOSFETs), diodes, etc., again, in general, n-channel or p-channel or both, vacuum tubes including diodes, triodes, tetrodes, pentodes, etc. and any other type of switch, etc. The present invention can, for example, be used with any type of power supply configuration and topology, including but not limited to, continuous conduction mode (CCM), critical conduction mode (CRM), discontinuous conduction mode (DCM), resonant modes, etc., of operation with any type of circuit topology including but not limited to buck, boost, buck-boost, boost-buck, cuk, etc., SEPIC, flyback, isolated or non-isolated power supplies, drivers, ballasts, chargers, etc. The present invention applies to all types of power supplies and sources and the respective power supply(ies) can be of a constant frequency, variable frequency, constant on time, constant off time, variable on time, variable off time, constant period, variable period, etc. Other forms of sources of power including thermal, optical, solar, radiated, mechanical energy, vibrational energy, thermionic, etc. are also included under the present invention. The present invention may be implemented in various and numerous forms and types including those involving integrated circuits (ICs) and discrete components and/or both. The present invention may be incorporated, in part or whole, into an IC, etc.

The present invention supports all standards and conventions for 0 to 10 V dimming or other dimming techniques. In addition the present invention can support, for example, overcurrent, overvoltage, short circuit, and over-temperature protection. Other embodiments can use other types of comparators and comparator configurations, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, DSPs, complex logic devices, field programmable gate arrays, etc.

The dimmer for dimmable drivers may use and be configured in continuous conduction mode (CCM), critical conduction mode (CRM), discontinuous conduction mode (DCM), resonant conduction modes, etc., with any type of circuit topology including but not limited to buck, boost, buck-boost, boost-buck, cuk, SEPIC, flyback, forward-converters, etc. The present invention works with both isolated and non-isolated designs including, but not limited to, buck, boost-buck, buck-boost, boost, push-pull, voltage mode and current mode forward-converters, flyback and other types of forward-converters, etc. The present invention itself may also be non-isolated or isolated, for example using a tag-along inductor or transformer winding or other isolating techniques, including, but not limited to, transformers including signal, gate, isolation, etc. transformers, optoisolators, optocouplers, etc.

The present invention includes other implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

The present invention can also incorporate at an appropriate location or locations one or more thermistors (i.e., either of a negative temperature coefficient [NTC] or a positive temperature coefficient [PTC]) to provide temperature-based load current limiting.

When the temperature rises at the selected monitoring point(s), the phase dimming of the present invention can be designed and implemented to drop, for example, by a factor of, for example, two. The output power, no matter where the circuit was originally in the dimming cycle, will also drop/decrease by a some factor. Values other than a factor of two (i.e., 50%) can also be used and are easily implemented in the present invention by, for example, changing components of the example circuits described here for the present invention. As an example, a resistor change would allow and result in a different phase/power decrease than a factor of two. The present invention can be made to have a rather instant more digital-like decrease in output power or a more gradual analog-like decrease, including, for example, a linear decrease in output phase or power once, for example, the temperature or other stimulus/signal(s) trigger/activate this thermal or other signal control.

In other embodiments, other temperature sensors may be used or connected to the circuit in other locations. The present invention also supports external dimming by, for example, an external analog and/or digital signal input. One or more of the embodiments discussed above may be used in practice either combined or separately including having and supporting both 0 to 10 V and digital dimming. The present invention can also be used with very high power factor circuits, drivers, ballast, chargers, power supplies, etc. The present invention can also be used to support dimming of a number of circuits, drivers, etc. including in parallel configurations. For example, more than one driver can be put together, grouped together with the present invention. Groupings can be done such that, for example, half of the dimmers are forward dimmers and half of the dimmers are reverse dimmers. Again, the present invention allows easy selection between forward and reverse dimming that can be performed manually, automatically, dynamically, algorithmically, can employ smart and intelligent dimming decisions, artificial intelligence, remote control, remote dimming, etc.

The present invention may provide thermal control or other types of control to, for example, a dimming LED driver, non-dimmable LED driver, FL, CFL, CCFL ballast, forward and/or reverse dimmer, and/or battery charger. For example, the circuits of FIGS. 1 through 14 or variations thereof may also be adapted to provide overvoltage or overcurrent protection, short circuit protection for, for example, a dimming LED driver, or to override and cut the phase and power to the dimming LED driver(s) based on any arbitrary external signal(s) and/or stimulus. The present invention can also include circuit breakers including solid state circuit breakers and other devices, circuits, systems, etc. That limit or trip in the event of an overload condition/situation. The present invention can also include, for example analog or digital controls including but not limited to wired (i.e., 0 to 10 V, RS 232, RS485, IEEE standards, SPI, I2C, other serial and parallel standards and interfaces, etc.), wireless, including, but not limited to, WiFi, ZigBee, ISM, IEEE 801, infrared and other parts of the electromagnetic spectrum, powerline, etc. and can be implemented in any part of the circuit for the present invention. The present invention can be used with a buck, a buck-boost, a boost-buck and/or a boost, flyback, or forward-converter design etc., topology, implementation, etc.

Other embodiments can use comparators, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, DSPs, complex logic devices, field programmable gate arrays, etc.

The present invention includes implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

In conclusion, the present invention provides novel apparatuses and methods for supplying circuits from multiple power sources in dimmable LED drivers, non-dimmable LED drivers, FL, CFL, CCFL ballasts, battery chargers, forward and reverse dimmers, etc. and in other applications. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. An apparatus for providing constant current comprises:
an alternating current input;
a pair of capacitors connected in parallel with a load output; and
a pair of diodes connected in parallel with the pair of capacitors, wherein a first lead of the alternating current input is connected between the pair of diodes and a second lead of the alternating current input is connected between the pair of capacitors, and wherein capacitances of the pair of capacitors are selected to produce a substantially constant current to the load output at a voltage lower than that of the alternating current input.
